(19) United States
(12) Patent Application Publication
(10) Pub. No.: US 2006/0031109 A1
(43) Pub. Date: Feb. 9, 2006

(54) System and method for staffing temporary medical positions

(75) Inventors: John Hayden LaRue JR., Dallas, TX (US); Jason Gardner, Plano, TX (US); Brian Kleinfall, Dallas, TX (US)

Correspondence Address: PATTON BOGGS, L.L.P., 2001 ROSS AVENUE, SUITE 3000, DALLAS, TX, 75201, US

(73) Assignee: Medical Contracting Services, Inc., Dallas, TX (US)

(21) Appl. No.: 11/200,523

(22) Filed: Aug. 9, 2005

Related U.S. Application Data
(60) Provisional application No. 60/599,990, filed on Aug. 9, 2004.

(51) Int. Cl. G06Q 10/00

(52) U.S. Cl. 705/9; 705/2

(57) ABSTRACT

A system and method for staffing temporary medical positions offered by medical service providers to medical professionals. Communications between the medical service providers and medical professionals may be via a temporary medical position staffing system, thereby increasing the rate and times at which the medical service providers and medical professionals can be performed. A medical service provider may order a temporary medical position to be filled and the system may generate communications with the medical professionals over a variety of different electronic mediums to notify the medical professionals about the temporary medical position. The system may provide for the medical professionals to negotiate with the medical service providers by negotiating negotiable terms, such as pay rate.

### CROSS REFERENCES TO RELATED APPLICATIONS

This application claims the benefit of priority to co-pending U.S. Provisional Patent Application 60/599,990, filed Aug. 9, 2004, which is herein incorporated by reference in its entirety.

### BACKGROUND OF THE INVENTION

There is a niche market for filling short-term or temporary medical position staffing needs. Very few medical staffing companies exist in this market because of the fast response needed and high overhead incurred to perform such activities. Typically, many short-term staffing positions go unfilled or are filled by less than desirable personnel because of the limited number of temporary medical position staffing companies. There are some agencies that fill these needs with on-staff personnel that they can call to readily fill short-term assignments. This causes a problem in that it often limits the client and candidate's (e.g., on-staff personnel) ability to interact with one another since each typically communicate through the agency during business hours only. Hospitals and other medical service providers that use medical staffing firms do not have the manpower to try to find candidates to fill these temporary medical positions themselves. One limiting factor is the costs of having someone available to call each candidate and determine their eligibility and interest in the position. Because of this cost factor, very few staffing companies are interested or willing to engage in such short-term temporary medical position fulfillment. Staffing of temporary medical positions may include staffing a position for a few hours or a few days, but typically no longer than thirteen days.

After years in the long-term medical staffing area, extensive lists of healthcare professionals from all over the country that are used to fulfill long-term staffing needs have been generated. Hospitals or medical facilities using these long-term staffing agencies contact the medical position staffing agencies to fill a short-term staffing need. In many cases, the potential candidates from the long-term staffing lists are required to travel, which costs a great deal in terms of travel expenses, including transportation, lodging, food, and other basic travel expenses that the hospitals or medical facilities are required to cover. This is a fundamental problem in the short-term medical position staffing industry.

One way that the medical staffing industry has attempted to alleviate such problems has been for the agencies creating web-based job boards in an attempt to locate local medical professionals to fill the short-term medical position staffing needs. Such a solution, however, has not significantly improved the short-term medical position staffing needs as the medical staffing agencies still perform all the communications between the medical professionals reviewing the job board for temporary medical positions and the medical service provider offering the position.

### SUMMARY OF THE INVENTION

To overcome the problems of existing techniques for staffing temporary medical positions, the principles of the present invention provide for direct communications between a medical service provider and medical professionals available to fill the temporary medical positions. One embodiment includes a system for staffing temporary medical positions. The system may include a database configured to store information associated with medical professionals eligible to fill temporary medical positions for medical service providers and a server in communication with said database and executing software. The server may be configured to receive a request from a medical service provider to staff a temporary medical position having specified qualifications at a geographic location for an offered pay rate over a time range, search said database of medical professionals to find one or more potential candidates having at least a portion of the specified qualifications and located within a predetermined distance of the geographic location to staff the temporary medical position, identify one or more potential candidates from the search, and initiate a communication to the one or more identified potential candidates by using a communication identifier stored in said database associated with the identified one or more potential candidates. The communication may include a description of the position, geographic location, offered pay rate, and time range of the temporary medical position.

### BRIEF DESCRIPTION OF THE DRAWINGS

FIG. 1 is an illustration representing exemplary communications between medical service providers, medical professionals, and a temporary medical position staffing agency;

FIG. 2 is a block diagram representing detailed communications between the medical service providers, medical professionals, and temporary medical position staffing agency of FIG. 1;

FIG. 3 is a flow chart describing an exemplary process for filling temporary medical positions in accordance with the principals of the present invention;

FIG. 4 is a flow diagram of an exemplary overall process for fulfilling temporary medical positions according to the principals of the present invention;

FIG. 5 is a web page showing an exemplary order form for submitting an order to a temporary medical position fulfillment system to fulfill a temporary medical position; and

FIGS. 6A and 6B (collectively FIG. 6) are a flow diagrams of an exemplary activity process for the temporary medical position fulfillment system in accordance with the principles of the present invention.

### DETAILED DESCRIPTION OF THE PRESENT INVENTION

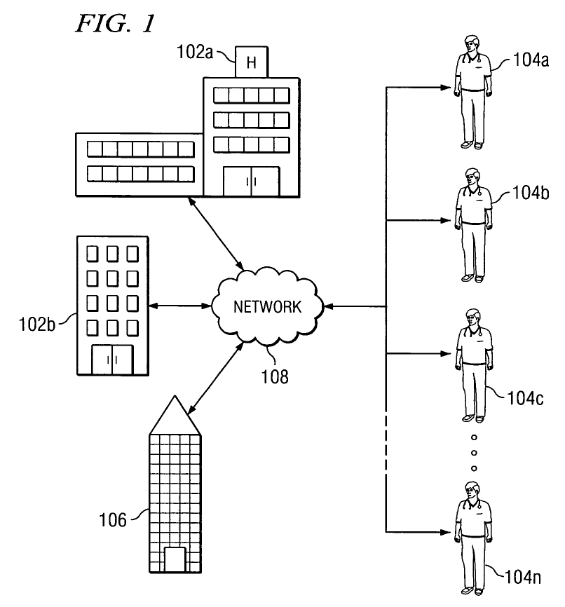

FIG. 1 is an illustration showing exemplary relations and communications 100 between medical service providers 102a and 102b (collectively 102), medical professionals 104a-104n (collectively 104), and a temporary medical position staffing agency 106. The medical service providers 102 may include hospitals, medical outpatient centers, individual doctors, physical therapy facilities, or any other medical provider that may have a need to fill temporary medical positions. The medical professionals 104 may include a variety of medical positions in the medical care industry, including medical equipment technicians, medical equipment operators, doctors, physical therapists, nurses, radiologists, hospice care workers, medical secretarial workers, or any other position in the medical care industry. The temporary medical position staffing agency 106 may be considered a facilitator to engage the medical service providers 102 with the medical professionals 104 offering and/or negotiating temporary medical positions. As shown, each of the medical providers 102 may communicate with the temporary medical position staffing agency 106 and medical professionals 104 via a network 108. The network 108 may be a public service telephone network (PSTN), cellular network, the Internet, or any other wired or wireless network capable of providing communications between the medical service providers 102, medical professionals 104, and temporary medical position staffing agency 106.

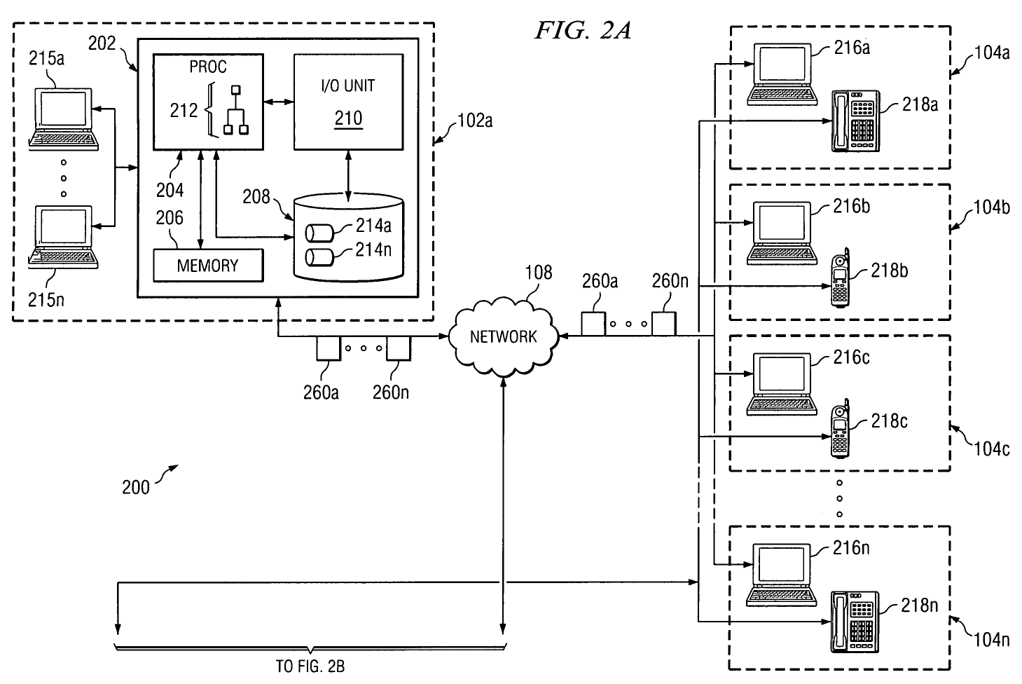

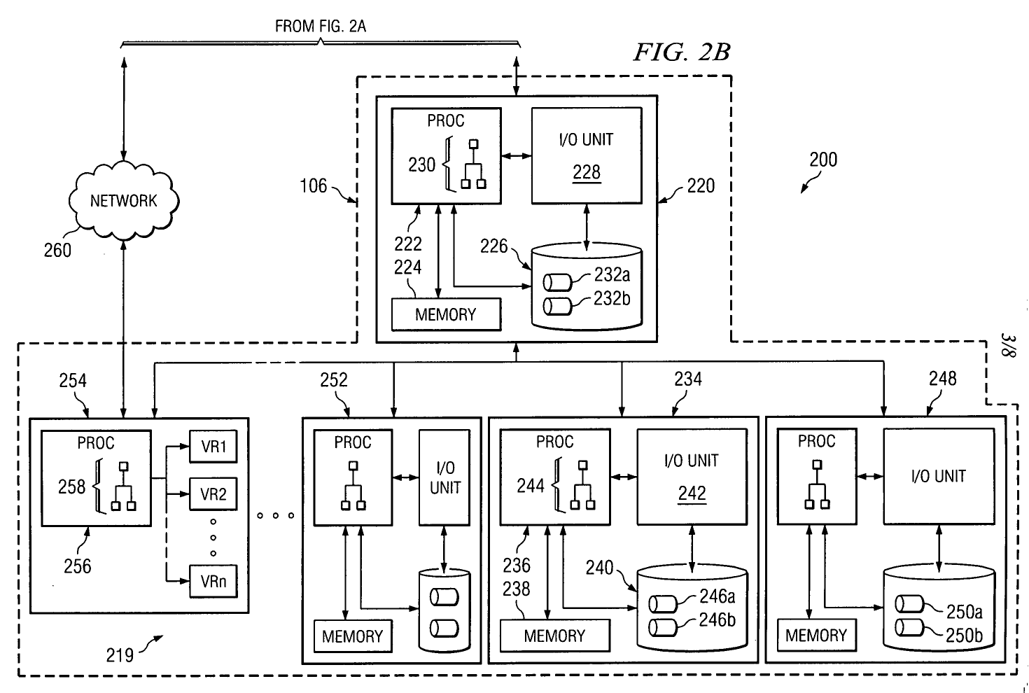

FIG. 2 is a block diagram representing detailed communications 200 between a medical service provider 102a, medical professionals 104, and temporary medical position staffing agency 106 of FIG. 1. The medical service provider 102a may utilize a server 202. The server 202 may include a processor in communication with a memory 206, storage unit 208, and input/output (I/O) unit 210. The processor 204 may execute software 212 to enable human resource managers at the medical service provider 102a to place orders for temporary medical positions to be filled. The storage unit 208 may store databases 214a-214b (collectively 214) to maintain information associated with temporary medical position orders.

The human resource managers may use personal computers 215a-215n (collectively 215) to communicate with the server 202. As understood in the art, the communications between the personal computers 215 and server 202 may be over a local area network (LAN), wide area network (LAN), or other networking architecture. The personal computers 215 may (i) have an application program residing thereon, (ii) interface with an application program executed by the processor 204 of the server 202, or (iii) interface with an application executing on a remote server.

Each of the medical professionals 104 may use one or more forms of wired or wireless communications devices. The communications devices may include computing systems 216a-216n (collectively 216) and telephones 218a-218n (collectively 218). The computing systems 216 may be personal computers, hand-held computers, or other computing device or network interface device capable of enabling the medical professionals 104 to interface with a short-term medical position staffing system operating on a network (e.g., network 108, FIG. 1). The telephones 218 may be conventional landline telephones, wireless telephones, mobile telephones, or other telephone operating on any existing or future wired or wireless communications protocol. The short-term medical position fulfillment system may provide a graphical user interface or other interface for medical professionals 104 to interact with the medical service providers 102 and temporary medical position staffing agency 106.

The temporary medical position staffing agency 106 may utilize and manage equipment that provides for a temporary medical position fulfillment or staffing system 219 to use a server 220 that includes a processor 222 in communication with a memory unit 224, storage unit 226, and input/output (I/O) unit 228. The processor 222 may execute a software program 230 that operates as or in conjunction with a system for fulfilling temporary medical positions. The storage unit 226 may store databases 232a-232b (collectively 232) that store information utilized by the software 230.

The server 220 may further be in communication with a number of computing and/or communication systems operated by the temporary medical position staffing agency 106 or a third-party service provider. One computing device may be a web server 234 that includes a processor 236 that communicates with a memory 238, storage device 240, and I/O unit 242. The processor 236 may execute software 244 that is configured to operate and manage a website. The storage device 240 may store databases 246a-246b (collectively 246) for storing information that is utilized on the website being hosted by the web server 234.

Another computing device in communication with the server 220 may be database server 248. The database server 248 may manage a structured query language (SQL) database as understood in the art. The database server 248 may operate and manage any other type of database or data reservoir capable of storing information. The database server 248 may include a processor and other components the same or similar to that of the server 220. Databases 250a-250b (collectively 250) may store information associated with the medical service providers, medical professionals, and temporary medical positions being offered by the medical service providers 102 to be staffed. External computing or communication devices, such as the server 220, may access the information stored in the databases 250. Another server that may be configured to communicate with the server 220, web server 234, and database server 248 may be an electronic messaging server 252. The electronic messaging server 252 may be configured to generate and send electronic messages to the medical service providers 102 and medical professionals 104 in response to the temporary medical position staffing system operating to fulfill temporary medical positions.

The temporary medical position staffing system may further include a voice-messaging server 254. The voice messaging server 254 may include a processor 256 executing software 258 that acts as a controller to control voice robots VR1-VRn (collectively VR). The voice robots VR operate to convert messages generated or received by the processor 256 from another computing device (e.g., server 220 or web server 234) to generate and communicate a voice message to a medical professional 104a via network 260 to the telephone 218a. The network 260 may be a public switch telephone network, the Internet, or other wired, wireless, or optical communication system. It should be understood that the computing and communication devices, such as the servers operated by the temporary medical position staffing agency 106, are exemplary in that other servers and devices may be utilized in accordance with the principles of the present invention. Further, the functionality of the servers shown may be consolidated or expanded into fewer or more servers or other computing or communication devices as understood in the art. Still yet, the servers may be managed by a third party and be utilized on a time sharing or other basis by the temporary medical position.

In operation, the server 220 interfaces with the network 108. The server 108 may communicate with one or more of the other servers being operated by the temporary medical position staffing agency 106 to manage and/or communicate information to or from the medical service providers 102 or medical professionals 104. In addition, the server 220 may be utilized in conjunction with the web server 234 to manage a website accessed by the medical service providers 102 and medical professionals 104 for staffing temporary medical positions. The information that is maintained, posted or collected by the website may be stored by the database server 248 in the databases 250 for use in fulfilling the temporary medical positions. In one embodiment, the personal computers 215 may be utilized by the medical service providers 102 to submit an order for temporary medical positions to be staffed. Medical professionals 104 may utilize the personal computers 216 to access the temporary medical position staffing system. As shown, communication over the network 108 may be in the form of data packets 260a-260n as understood in the art. It should be understood that other communication protocols may be utilized to communicate information over the networks 108 and 260 for communications between the medical service providers 102 and medical professionals 104 via the temporary medical position staffing system.

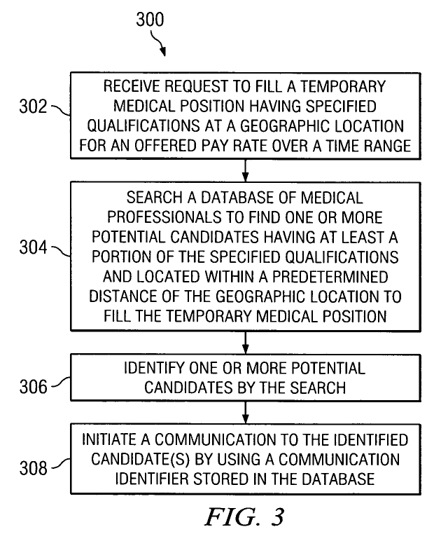

FIG. 3 is a flow chart describing an exemplary process for filling temporary medical positions in accordance with the principals of the present invention. In one embodiment, the steps shown in the flow chart may be performed by utilizing the communications system shown in FIG. 2. The temporary medical position staffing process starts at step 302, where a request is received to staff or fill a temporary medical position having specified qualifications at a geographic location for an offered pay rate over a time range or schedule. The qualifications may include education, experience level, experience on particular medical equipment, number of years of experience, specific certifications, age, gender, specific skills, physical characteristics, or other qualifications as understood in the art. The geographic location may be identified by a name of a building (e.g., General Hospital), street address, city, or other identifier indicating location of a facility or other location (e.g., house of a patient) ordered to have a temporary medical position filled. The offered pay rate may be a pay rate in dollars per hour, fixed or lump sum amount over a certain time period, or other method for paying a medical professional for working for a certain amount of time or performing certain functions. For example, the pay rate may be for a certain number of dollars per hour or be for a certain amount of dollars per task, such as performing scans using a magnetic resonance imaging (MRI) system on patients. In addition, the pay rate may include or be separate from other types of differential pay, including on call pay differential, evening shift pay differential, graveyard shift pay differential, and weekend shift pay differential. Other ways of determining pay rate may further be utilized. Typically, the request is received from a medical provider, such as a hospital or emergency care facility, but other third party or agents may submit the request for a medical service provider.

At step 304, a database search of medical professionals to find one or more potential candidates having at least a portion of the specified qualifications and located within a predetermined distance of the geographic location to fill the temporary medical position may be performed. The search may not be able to find a medical professional in the database of medical professionals (e.g., database 250 of FIG. 2) fully matching the request from the medical service provider, so one or more potential candidates having qualifications that match one or more of the specified qualifications may be identified and ranked during the search. The ranking may set a value indicative of how well the potential candidates match the desired qualifications. For example, the ranking may set a value between 0 and 100. Alternatively, the ranking may set a value between 0-10. Still yet, symbols, such as stars or bar graph, may be used to represent the closeness of the match. The medical professionals may be sorted based on the rankings to provide the medical service providers an easy way to view the best matched potential candidates.

The search may be limited to a predetermined distance based on the geographic location received for the temporary medical position. In determining the distance, the principals of the present invention may utilize a longitude and latitude algorithm for a particular street address or zip code. The search algorithm may thereafter determine the location of the potential candidates based on street address or zip code, for example, and perform a distance calculation between the geographic location of the temporary medical position and the medical professionals in the database available to fulfill the positions.

At step 306, one or more potential candidates may be identified by the search. The identification may include tagging or storing an identifier associated with the potential candidates found during the search that meet at least a portion of the specified qualifications and located within a predetermined distance of the geographic location of the temporary medical position to be filled. In one embodiment, the distance may be increased or decreased during the search to increase or decrease the number of medical professionals found in the search.

An electronic communication may be initiated to the identified candidate(s) by using a communication identifier stored in the database. The communication identifier may be an email address, telephone address, text message address, instant message address, or other electronic address capable of receiving electronic communication. The electronic communication may be a voice generated by a voice robot, email or text message generated by an email generator operating on an electronic messaging server 252 (FIG. 2), or other electronic communication. It should be noted that the fulfillment or staffing process of FIG. 3 may be completely performed without human interaction at the temporary medical position staffing agency 106 (FIG. 1). This enables communications between the medical service providers 102 and medical professionals 104 to be independent of a third party and at a substantially higher rate than if a third party (e.g., temporary medical position staffing agency) were involved to find medical professionals meeting the desired qualifications and negotiate with the medical professionals 104 and medical service providers 102.

The process for staffing a temporary medical position includes submission of the temporary medical position by the medical service provider to the temporary medical position fulfillment system, communication to potential candidates that meet the qualifications of the temporary medical position, and negotiation between the medical professionals identified by a temporary medical position fulfillment system and the medical service provider. In performing these and the steps of the process shown in FIG. 3, a number of inputs and responses may be performed by the medical service provider looking to fill a temporary medical position and the medical professionals wanting those temporary medical positions.

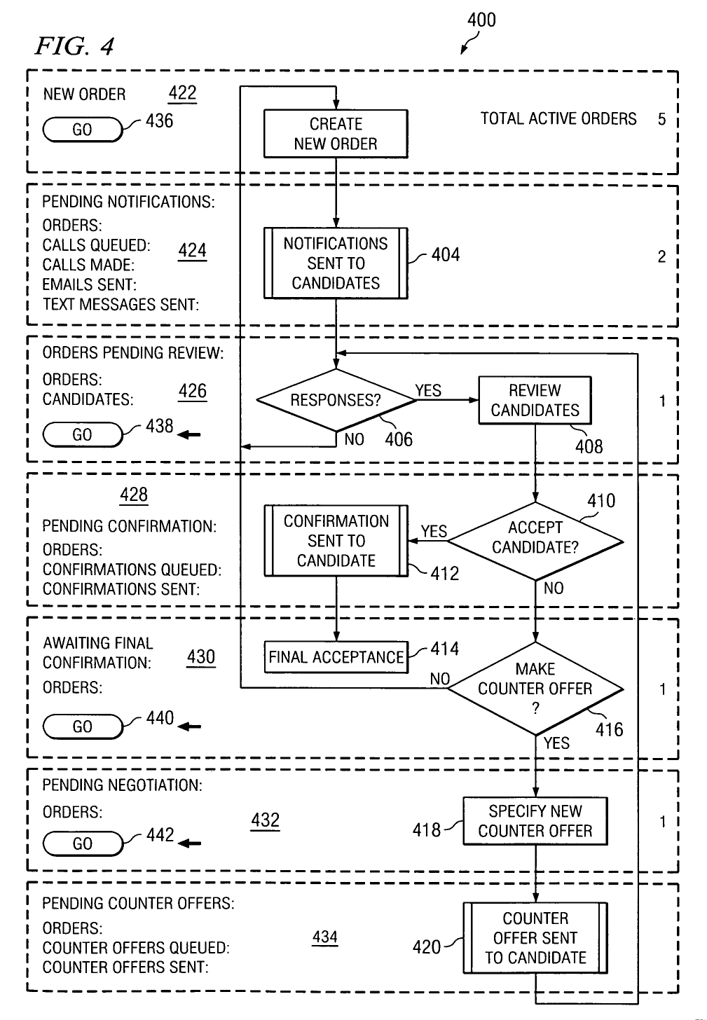

FIG. 4 is a flow diagram 400 of an exemplary overall process for fulfilling temporary medical positions according to the principals of the present invention. The process starts at step 402 where a medical service provider or customer of a temporary medical position staffing agency may create a new order to hire a medical professional to fill a temporary medical position. At step 404, notifications may be sent to potential candidates based on a search of medical professionals available to fulfill the temporary medical position requested by the medical service provider. At step 406, a determination may be made as to whether any responses have been received for the temporary medical position requested or ordered to be staffed by the medical service provider. If no responses have been received at step 406, the medical service provider may create another order at step 402.

If any responses have been received from medical professionals in response to the notification sent about the temporary medical position, then the medical service provider may review the candidates at step 408 to determine whether any of the candidates are acceptable for hiring. At step 410, the medical service provider may make a decision to accept or reject candidates who have responded to the notification. If the medical service provider accepts a candidate, then a confirmation may be sent to the candidate at step 412 notifying the candidate of the acceptance. The confirmation may request from the candidate a final acceptance at step 414 to complete the transaction.

If the candidate is not accepted at step 410, then at step 416, the candidate may make a counteroffer to the medical service provider. If it is determined that a counteroffer is not to be made from the candidate to the medical service provider at step 416, then the medical service provider may simply create a new order at step 402. If the candidate decides to make a counteroffer to the medical service provider at step 416, then a new counteroffer may be specified as step 418. The counteroffer may be sent to the medical service provider at step 420 with a receipt being sent to the candidate. The counteroffer may be for more or less money than offered by the medical service provider. A candidate may counteroffer for more money if he or she feels that the offered pay rate is too low or the candidate may ask for less money if he or she wants to try and ensure that he or she is selected for the position. The process continues at step 406 where the medical service provider may be notified of pending counteroffers or other candidates to review.

Continuing with FIG. 4, the steps of the process 400 are arranged within dashed boxes to show the stages of each step in the process. These stages may be displayed on a graphical user interface (GUI) for a user to quickly identify the stage and status of the offering and negotiation process while using the temporary medical position staffing system. As shown, there are seven stages. The number of stages may be expanded or contracted to provide information to a user of the system in a different format.

Stage 422 is a new order stage, where a medical service provider may create a new order. Stage 424 shows any notifications, including orders, calls queued, calls made, emails sent, and text messages sent. The information may include a numerical value (e.g., calls made: 6) or other indicia representative of notifications pending to be sent or having been sent to potential candidates to staff the temporary medical position staffing positions.

Stage 426 is the orders pending review stage where the medical service provider may review pending orders and candidates. Stage 428 is a pending confirmation stage where orders, confirmations queued, and confirmations sent may be viewed by the medical service provider.

Stage 430 is an awaiting mail confirmation stage that shows any orders that are waiting final acceptance. To make it easy on the user, the orders may be shown as a numerical value or other graphical or textual representation to provide the user with the number of acceptances awaiting confirmation.

Stage 432 is a pending negotiation stage that shows the number of orders waiting negotiations, such as a counteroffer, from potential candidates.

Stage 434 is a pending counteroffer stage that the user may view orders, counteroffers queued, and counteroffers sent. Again, these may be numerical, alpha numerical, or graphical representations to provide the user with information about the pending counteroffers stage.

In each of these stages, a graphical representation may be displayed on a GUI that include one or more GUI elements for the user at the medical service provider to view and track orders, confirmations, negotiations, counteroffers, or other stages for staffing temporary medical positions. The GUI elements may include a push button that can be selected to display additional information related to that stage as understood in the art.

The following tables are exemplary input and response tables that may be utilized by the temporary medical position fulfillment system of FIG. 2. These tables include exemplary data that may be stored and representative of GUI elements that may be provided to users of the temporary medical position staffing system.

Table I is an exemplary input table for a medical service provider to input contact information. The contact information may include a facility name, contact first and last name, contact title, facility address, and electronic contact addresses. The system may utilize the electronic contact addresses or communication identifier to send electronic communications to the contact at the medical service provider in one embodiment. Alternatively, the temporary medical position staffing system may post communication information on a website or other network location for the contact at the medical service provider to access. Still yet, the electronic contact information may be utilized to notify the contact at the medical service provider that a posting has been made and available for review or response.

TABLE I
Medical Service Provider Contact Information

| | |
|---|---|
| Facility Name | MCS Test Facility |
| First Name | Gregory |
| Last Name | Smith |
| Title | Radiology Director |
| Address | 10300 N Central Expwy |
| | Suite 3000 |
| City | Dallas |
| State | Texas |
| Zip | 75231 |
| Phone | (214) 567-8901 |
| Extension | |
| Fax | (999) 999-9999 |
| Email | gsmith@medicalcontracting.com |

Table II provides an exemplary temporary medical position request form for a medical service provider to enter information describing the temporary medical position available to be filled. The form may include skill/modality (e.g., testing), size of the facility, registrations or certifications desired or required for the position, the starting date, duration of the position, the shift start and end time, work days, on call hours, workload, dress code, and equipment, for example. It should be understood that other information related to the work environment, desired or required certifications, or other information related to the temporary medical position available to be filled may be included in the temporary medical position request form. Accordingly, because this form may be provided in a graphical user interface environment, entry of the information related to the temporary medical position may be available utilizing software tools, such as pull down menus, check boxes, radio buttons, and other software tools to make it faster and easier for the medical service provider to enter information into the temporary medical position staffing system in accordance with the principals of the present invention. Still yet, some information may be entered in text boxes to provide additional description about the temporary medical position.

TABLE II
Temporary Medical Position Request Form

| Skill/Modality | Testing | |
|---|---|---|
| Size of Facility | 150-499 beds | |
| Registration | ARRT - Radiology | |
| | RDMS - Ultrasound | |
| | NMTCB/AART - NucMed | |
| | CV-Cathlab | |
| Start Date | Jul. 14, 2005 | [symbol] Begin Assignment ASAP |
| Duration | 3 days | [symbol] Indefinite Assignment Duration |
| Shift Start Time Hours | 07:05 AM | hour/minutes/AMPM |
| Shift End Time Hours | 04:00 AM | hour/minutes/AMPM |

| | |
|---|---|
| Work Days | [symbol] Sun [symbol] Mon [symbol] Tues [symbol] Wed [symbol] Thu [symbol] Fri [symbol] Sat |
| On Call Hours | No |
| Work Load | Light |
| Dress code | Lab Coat |
| Equipment | |

Table III shows an exemplary order rates entry form for a medical service provider to enter offered pay rates to potential candidates to fulfill the temporary medical positions. The entry form may include regular rates (e.g., dollars per hour), on call pay rates, per scan pay rates, evening shift differential pay rates, graveyard shift differential pay rates, and weekend shift differential pay rates. In addition, the table may provide typical pay rates paid in the local area of the medical service provider submitting a temporary medical position to be filled. It should be understood that the entry form may alternatively provide for pay rates that are not dollars per hour depending on how the medical service provider pays for temporary medical positions to be filled. The typical pay rates for the local area may be determined as an average of the pay rates in the local area, by competitor analysis (e.g., competing types of medical service providers), or other local, regional, or national pay rate for a particular type of position.

One embodiment for setting the pay rates includes utilizing historical pay rates accepted by the medical professionals. The temporary medical position staffing system may store historical negotiated pay rates for particular positions (e.g., MRI system operator) in a database as related to location (e.g., associated with zip codes) and collect those historical pay rates to determine min, max, and median, for example. The historical pay rates may then be used for display, recommendation, or setting for a message to medical professionals. While the system may be able to collect historical pay rates, the system may also provide an override feature to enable the medical service provider to override historical pay rates. For example, if the medical service provider absolutely needs a particular position to be filled, a rate higher than the historical pay rates may be input. Alternatively, if there is a budget crisis and the medical service provider cannot afford to pay historical pay rates, then the pay rate may be set by the medical service provider at a lower pay rate than historically set. A map or other graphical representation may be provided by the system to show the historical pay rates graphically over certain locations or regions. The same or similar techniques may be used for differential pay rates for different shifts, on call, and the like.

The historical information may be based on density of the location at which a medical service provider is attempting to fill a position, so the search distance being set may be variable to enable the medical service provider to adjust the search distance real-time to find the distance from the facility at which the temporary medical position that fits their desires. For example, if the facility is located in a rural area, the distance may need to be expanded to find medical professionals who are willing to work for less money. Alternatively, if the facility is located in a dense population area, the distance parameter may be reduced to find medical professionals who are willing to work for less money. In one embodiment, the temporary medical position staffing system may utilize a look-up table or other database to determine population density for setting or adjusting the search distance. For example, the system may be set up to search a population of 100,000 people, which may result in 25 medical professionals having matching desired qualifications for the temporary medical position being ordered by the medical service provider. A medical service provider located in a high population city may search a circle or other geometric shape around the location of the temporary medical position of ½ mile radius. In a suburb, the radius may be 2 1/2 miles to search a population of 100,000 people. A maximum range may be set to which the search distance may be expanded.

TABLE III
Order Rates Entry Form

| Bill Type | Rates | Typical Rates |
|---|---|---|
| Regular | $54.00 | Typical range for your area is $45.00 to $65.00 |
| On Call | $4.00 | Typical range for your area is $2.00 to $8.00. |
| Per Scan | $62.00 | Typical range for your area is $55.00 to $75.00. |
| Evening | $4.00 | Typical range for your area is $3.00 to $5.00. |
| Shift Diff | | |
| Graveyard | $4.00 | Typical range for your area is $3.00 to $5.00. |
| Shift Diff | | |
| Weekend | $4.00 | Typical range for your area is $3.00 to $5.00 |
| Shift Diff | | |

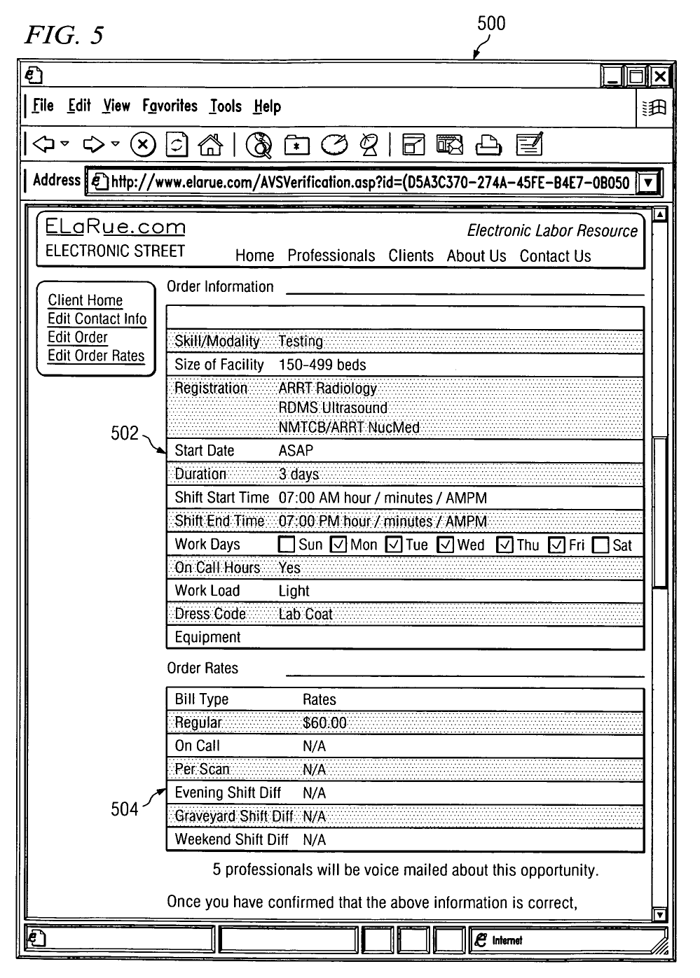

FIG. 5 is a web page 500 showing an exemplary order form for submitting an order to the temporary medical position staffing system to staff a temporary medical position. Based on preferences or a selection by the medical service provider, a certain number of medical professionals may be communicated with about the position. For example, a medical service provider may either elect to communicate with five medical professionals and have a voice and/or text message communicated to the medical professionals. As shown, the order information 502 may include the information entered by the medical service provider about the temporary medical position and pay rates 504 to be paid to a medical professional for working the temporary medical position. A confirmation soft-button or other selectable element may be provided for a person, such as a staffing administrator, for the medical service provider to confirm that the information in the order is correct and that the medical service provider agrees to be bound by the terms and conditions for using the temporary medical position staffing system.

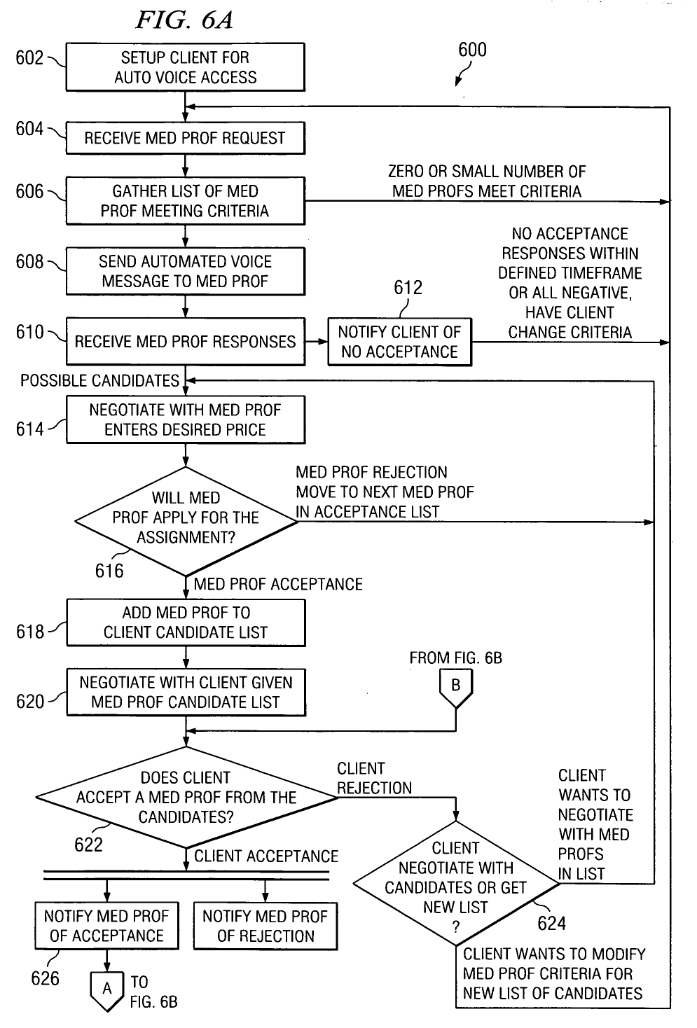

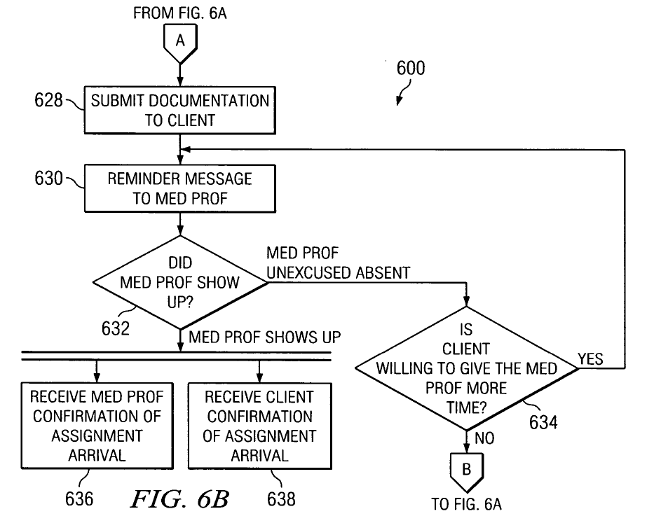

FIG. 6A is a flow diagram of an exemplary activity process 600 for the temporary medical position fulfillment system in accordance with the principles of the present invention. The process 600 starts at step 602, where a medical service provider may be set up for voice access. At step 604, a request for medical professional is received. A list of medical professionals meeting the medical professional request of step 604 is gathered or identified at step 606. The list may be stored in a temporary memory, such as memory 224 (FIG. 2), or storage device, such as storage device 226 in a database or other storage reservoir. The identification may result from a search. In one embodiment, the search utilizes distance between the location of the temporary medical position and the medical professionals having skills that meet the criteria established by the medical service provider. A database containing medical professionals available to fill temporary medical positions may be indexed prior to performing the search as understood in the art.

The database may store zip codes associated with the medical service providers and medical professionals. The database may store longitudes and latitudes associated with each zip code to enable the temporary medical position staffing fulfillment or staffing system. The following function may be used to determine the distance between one zip code (e.g., the location for the temporary medical position) and another zip code (e.g., residence of the medical professional). It should be understood that other functions and equations may be utilized to compute distance between two points. This may be used in the context of an SQL server user defined function, so it can be used in the limiting criteria.

```
    CREATE FUNCTION fn_MCS_ZipCodeRadius (@lat float,@lon
float, @lat2 float, @lon2 float)
    RETURNS float AS
    BEGIN
    /* usage : select dbo.fn_MCS_ZipCodeRadius(0.999999,0.999999,
zipLatitude, zipLongitude)
        This function will return the mileage distance between the
points signified by the following
          @lat, @lon - latitude and longitude of first point
          @lat2, @lon2 - latitude and longitude of second point
    */
    declare @fReturn float
          select @fReturn = acos(convert(decimal(10,9),sin(@lat) *
sin(@lat2) + cos(@lat) * cos(@lat2) * cos(@lon2 - @lon))) * 3963
    return @fReturn
    END
```

Continuing with FIG. 6A, if it is determined that the list of medical professionals meeting the criteria specified by the medical service provider is zero or too small at step 606, then the process 600 returns to step 604 to submit a new order for a temporary medical position to be filled. For example, the criteria for a new order may increase the pay rate or reduce the certifications required. If a sufficient number of medical professionals are found and identified in the database from the search, then a message is sent to the identified medical professionals at step 608. In one embodiment, the message is an automated voice message generated by a voice robot. Additionally and/or alternatively, the message is an email, text, or other electronic message. At step 610, medical professional responses to the message are received. If it is determined that no acceptances to the message are received in a certain timeframe or all responses are rejections at step 612, then the process 600 returns to step 604 for the criteria of the temporary medical position to be expanded. A message may be sent or posted for the medical service provider indicating that no positive responses were received and requesting that the criteria be altered to improve the chances for a positive response.

If there are one or more positive responses to the message from medical professionals who are sent the message, then the process continues at step 614. The medical professionals who respond are considered potential candidates for the temporary medical position being offered by the medical service provider. Step 614 is considered the start of negotiations between the medical service provider and medical professional. The medical professional may enter a counteroffer at this point. The counteroffer may be a counteroffer to the pay rate, hours, or any other parameter that is available to be negotiated. If it is determined that the medical professional rejects the temporary medical position or assignment at step 616, then the process 600 continues at step 614 for additional negotiations. If it is determined that the medical professional accepts the assignment at step 616, then the process 600 continues at step 618, where the medical professional is added to a potential candidate list.

At step 620, a negotiation with the medical service provider or client may be negotiated with given the medical professional candidate list. At step 622, a determination is made whether the medical service provider accepts a medical professional from the list of potential candidates. If the medical service provider does not accept any of the potential candidates, then the process continues at step 624. If at step 624 it is determined that the medical service provider desires to continue negotiating with the potential candidates, the process returns to step 614. Otherwise, the process 600 returns to step 604 if the medical service provider wants to create a new order with modified criteria to find a new list of potential candidates to fulfill the temporary medical position.

If it is determined at step 622 that the client accepts a potential candidate, then the process 600 continues at step 626, where the system notifies the medical professional of being accepted by the medical service provider to fill the temporary medical position. Potential candidates who are not accepted may also be notified that they were rejected or not selected to fill the position. The process continues on FIG. 6B at step 628, where documentation is submitted to the medical service provider that describes the temporary medical position that was filled with the selected medical professional. At step 630, a reminder message may be sent to the medical professional that includes information about the temporary medical position, include dates, times, location, directions, or any other information necessary or helpful for the medical professional to find and perform the work.

At step 632, a determination is made as to whether the selected medical professional showed up to work. If the medical professional did not show up to work and there is the absence is unexcused, then the process continues at step 634, where a determination is made as to whether the client is willing to give the selected medical professional more time to arrive at work. Because of the short timeframes of the temporary medical position staffing, it may be possible to find a previously rejected candidate available to fill the vacant position. If not, the process 600 continues on FIG. 6A at step 622. Otherwise, the process continues at step 630 where another reminder message, such as an automated telephone call or text message, is communicated to the selected medical professional.

If it is determined at step 632 that the medical professional showed up to work, then the process continues at step 634 where the medical professional may confirm that he or she arrived via an email, text message, telephone call, or other electronic communication utilizing a communication identifier associated with the medical professional. The medical service provider may also confirm arrival of the medical professional via an electronic communication at step 636. The process 600 is complete at this point.

During the process 600, the medical provider may view the orders that have been made and their status. Table IV is an exemplary order listing. As shown, the orders listing may include the client contact name, skill or position being sought, status, order date, start date, and work hours. Other relevant information may be included on the list as well, such as name of client, name and location of facility for temporary medical position, and telephone number or other electronic email address.

TABLE IV
Medical Service Provider Orders

| Client Contact | Skill | Status | Order Date | Start Date | Work Hours |
|---|---|---|---|---|---|
| Smith, Gregory | Testing | Open | Aug. 06, 2005 | Aug. 07, 2005 | 07:00 AM-07:00 PM |
| | | | | | MTWTF |
| Saturnelli, Anne | MRI | Open | Aug. 05, 2005 | Aug. 12, 2005 | 07:00 AM-07:00 PM MWF |
| Lochner, Eric | Physical | Open | Aug. 06, 2005 | Aug. 08, 2005 | 07:00 AM-07:00 PM MWF |
| | Therapy | | | | |
| Singer, Risa | Occupational | Filled | Aug. 05, 2005 | Aug. 10, 2005 | 07:00 AM-07:00 PM MWF |
| | Therapy | | | | |

TABLE V is a detailed order that is available for the medical service provider to review utilizing the temporary medical position staffing system. The medical service provider may review the order and select to cancel the order if there is no need to fill the position anymore by selecting a soft-button on a webpage being managed by the temporary medical position staffing agency.

TABLE V
Order Request

| | |
|---|---|
| Skill/Modality | Testing |
| Size of Facility | 150-499 beds |
| Registration | ARRT - Radiology |
| | RDMS - Ultrasound |
| | NMTCB/AART- NucMed |
| Start Date | Aug. 06, 2004 |
| Duration | 3 days |
| Shift Start Time Hours | 07:00 AM hour/minutes/AMPM |
| Shift End Time Hours | 07:00 PM hour/minutes/AMPM |
| Work Days | [symbol] Sun [symbol] Mon [symbol] Tues [symbol] Wed [symbol] Thu [symbol] Fri [symbol] Sat |
| On Call Hours | Yes [symbol] |
| Work Load | Light |
| Dress code | Lab Coat |
| Equipment | |

Cancel Order

In response to a message sent to the medical professionals, the medical professionals may accept, counteroffer, not reply, confirm, and decline the offer for a temporary medical position. TABLE VI provides an exemplary list of responses from the medical professionals and descriptions of the meaning of the responses.

TABLE VI
Response List and Descriptions

| Response | Description |
|---|---|
| Accepted | The medical professional has accepted your initial offer, |
| | or your counteroffer at the rates listed. |
| Counter | The medical professional has submitted a counteroffer of the |
| | rates he or she would like to have for accepting the position. |
| No Reply | The medical professional has not yet replied to your |
| | counteroffer. |
| Confirmed | You have accepted the medical professional and the medical |
| | professional has confirmed acceptance of the assignment |
| Declined | The medical professional has declined your offer. |

The temporary medical position staffing system may provide the medical professional with a screen including a table or other form showing a current offer by the medical service provider that allows the medical professional to enter and submit a counteroffer. TABLE VII shows an exemplary counteroffer form, where the current offer column includes pay rates entered by the medical service provider and provided to the medical professional. The counteroffer column is composed of text fields or other input fields on a GUI or other format that enables the medical professional to enter counteroffer pay rates for a variety of negotiable terms. It should be understood that other negotiable terms may be made available to the medical professional for counteroffer, such as start time, duration, or otherwise. GUI elements, such as soft-buttons, may be provided for the medical professional to select after entering the counteroffer terms to submit or cancel the counteroffer.

TABLE VII
Counteroffer Form

| | |
|---|---|
| Current Offer | Counteroffer |

| | | | |
|---|---|---|---|
| Base Rate | $69.23 | | $72.23 |
| On Call | $.00 | | $2.00 |
| Per Scan | $.00 | | $0.00 |
| Evening Shift Diff | $.00 | | $2.00 |
| Graveyard Shift Diff | $.00 | | $4.00 |
| Weekend Shift Diff | $.00 | | $4.00 |
| | Submit | Cancel | |

A calendar function showing days of the week and time of the day may be included in the temporary medical position staffing system that graphically shows the medical professional times that the temporary medical position is to be filled. TABLE VIII is a calendar portion for a single week. It should be understood that a daily, monthly, or yearly calendar could alternatively been provided. The shaded portion shows the hours available for the position to be staffed. It should be understood that other indicia could also be used to show the available times. In one embodiment, the calendar function may enable the medical professional to select the time blocks by “sweeping” with a pointer or other GUI function or enter his or her name in the available blocks. A GUI element, such as a push button, may enable the medical professional to submit his or her name for the desired time to be considered for the temporary medical position.

TABLE VIII
Calendar

| | SUN | MON | TUE | WED | THU | FRI | SAT |
|---|---|---|---|---|---|---|---|
| 07:00 AM | | | 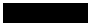 | 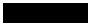 | | 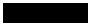 | |
| 07:30 AM | | | 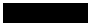 | 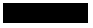 | | 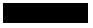 | |
| 08:00 AM | | | 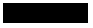 | 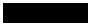 | | 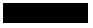 | |
| 08:30 AM | | | 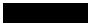 | 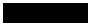 | | 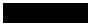 | |
| 09:00 AM | 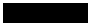 | | 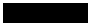 | 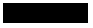 | | 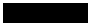 | |
| 09:30 AM | 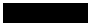 | | 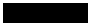 | | | 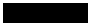 | |
| 10:00 AM | 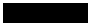 | | 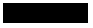 | | | 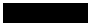 | |
| 10:30 AM | 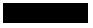 | | 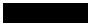 | | | 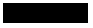 | |
| 11:00 AM | 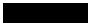 | | 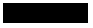 | | | 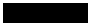 | |
| 11:30 AM | | | | | | | |
| 12:00 PM | | | 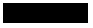 | | | | |
| 12:30 PM | | | 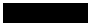 | | | 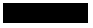 | |
| 01:00 PM | | | 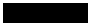 | | | 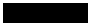 | |
| 01:30 PM | | | 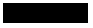 | | | 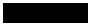 | |
| 02:00 PM | 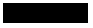 | | 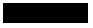 | 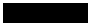 | | 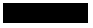 | |
| 02:30 PM | 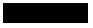 | | 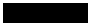 | 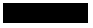 | | 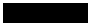 | |
| 03:00 PM | 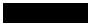 | | 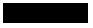 | 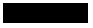 | | 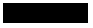 | |
| 03:30 PM | 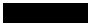 | | 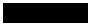 | 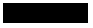 | | 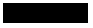 | |
| 04:00 PM | 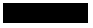 | | 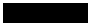 | 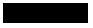 | | 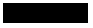 | |
| 04:30 PM | | | 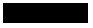 | 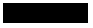 | | 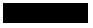 | |
| 05:00 PM | | | 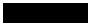 | 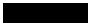 | | 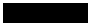 | |
| 05:30 PM | | | 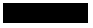 | 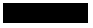 | | | |
| 06:00 PM | | | 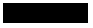 | 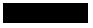 | | | |
| 06:30 PM | | | | 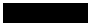 | | | |

The temporary medical position staffing system may generate a contract pursuant to the terms provided by the medical service provider and negotiated between the medical professional and medical service provider. The negotiated terms (e.g., pay rates) may be filled in the contract after an acceptance of the terms by the medical professional and medical service provider. A message or posting may be utilized to notify the medical professional and medical service provider of the completed contract for viewing and printing. The contract may be stored on the system and accessed by both parties. The medical professional may be prompted by a message shown in TABLE IX to agree to the terms of the contract. If the medical professional agrees with the contract, then the medical professional may select a soft-button to indicate that he or she agrees to the terms of the contract and submit, reject, or cancel. It should be understood that the temporary medical position staffing system may enable acceptance of the contract to be performed in alternative ways.

TABLE IX
Contract Acceptance Message

Please confirm that you agree to fulfill the assignment per the terms
outlined in the contract by clicking the checkbox labeled “I Agree”
below then clicking the submit button at the bottom of this screen.

[symbol]

I Agree

| | | | |
|---|---|---|---|
| View Contract | Submit | Reject | Cancel |

Another embodiment according to the principles of the present invention may provide for the medical professionals to report their availability via an interface to the temporary medical position staffing system. The interface may be a calendar, such as the one shown in TABLE VIII, which allows them to show their availability on certain days and over certain hours. The medical professional may further set their desired pay rates associated with their availability. This function may operate as a reverse auction type of model to entice medical service providers to hire the medical professionals because their rates are low. Still yet, the medical service providers may start their search by reviewing the available medical professionals and make an offer directly to those who are posted, thereby improving the chances of the medical professionals to be hired.

Specific embodiments according to the principles of the present invention have been described for the purpose of illustrating the manner in which the invention may be made and used. For example, the principles of the present invention maybe utilized in another field of business, such as an engineering consulting field. It should be understood that the implementation of other variations and modifications and its various aspects will be apparent to one skilled in the art, and that the invention is not limited by the specific embodiments described.

We claim:

1. A system for staffing temporary medical positions, comprising:
a database configured to store information associated with medical professionals eligible to fill temporary medical positions for medical service providers;
a server in communication with said database and executing software configured to:
receive a request from a medical service provider to staff a temporary medical position having specified qualifications at a geographic location for an offered pay rate over a time range;
search said database of medical professionals to find one or more potential candidates having at least a portion of the specified qualifications and located within a predetermined distance of the geographic location to staff the temporary medical position;
identify one or more potential candidates from the search; and
initiate a communication to the one or more identified potential candidates by using a communication identifier stored in said database associated with the identified one or more potential candidates, the communication including a description of the position, geographic location, offered pay rate, and time range of the temporary medical position.

2. The system according to claim 1, further comprising a website located on the Internet having an entry form located thereon for a medical service provider to enter information about the temporary medical position.

3. The system according to claim 1, wherein the specified qualifications cause said server to communicate with said database to search for potential candidates having education and experience matching the specified qualifications.

4. The system according to claim 1, wherein the search for specified qualifications causes said server to communicate with said database to search for experience using particular medical equipment.

5. The system according to claim 1, wherein the search for a medical professional includes the software being executed by said server establishing a longitude and latitude associated with the geographic location of the temporary medical position and longitude and latitude of a potential candidate.

6. The system according to claim 5, wherein establishing the longitude and latitude is based on zip code.

7. The system according to claim 5, wherein the software is further configured to determine the distance between the temporary medical position and potential candidate during the search.

8. The system according to claim 1, wherein the software is further configured to set the predetermined distance by which to restrict searching for a potential candidate.

9. The system according to claim 8, wherein the software is further configured to adjust the predetermined distance if the search is unsuccessful.

10. The system according to claim 8, wherein the software sets the predetermined distance based on population density at the geographic location.

11. The system according to claim 1, wherein said server initiates the communication by causing at least one of the following to be sent:
a telephone call, email, text message, instant message, and posted message.

12. The system according to claim 11, wherein said server initiates the communication without human intervention.

13. The system according to claim 1, wherein the software is further configured to receive an acceptance or counteroffer from the potential candidate of the offered pay rate.

14. The system according to claim 13, wherein the software is further configured to provide communications until negotiations between the potential candidate and medical service provider are complete by the potential candidate accepting or rejecting the temporary medical position or the position being filled or withdrawn by the medical service provider.

15. The system according to claim 1, wherein the software is further configured to set the pay rate based on historical rates relative to the geographic location.

16. The system according to claim 1, wherein said server is further configured to rank the one or more potential candidates as a match for the temporary medical position based on the specified qualifications for the temporary medical position and the qualifications of the one or more potential candidates stored in the database.

17. A method for staffing temporary medical positions, said method comprising:
receiving a request at a computing device to staff a temporary medical position having specified qualifications at a geographic location for an offered pay rate over a time range;
searching a database of medical professionals by the computing device to find one or more potential candidates having at least a portion of the specified qualifications and located within a predetermined distance of the geographic location to staff the temporary medical position;
identifying a potential candidate by the search; and
initiating a communication to the one or more identified potential candidate by the computing device by using a communication identifier stored in the database associated with the identified potential candidate, the communication including a description of the temporary medical position, geographic location, offered pay rate, and time range for the temporary medical position.

18. The method according to claim 17, wherein the received request is generated by an entry from the medical service provider via an entry form available at a website located on a network.

19. The method according to claim 17, wherein searching for specified qualifications includes searching education and experience of a medical professional.

20. The method according to claim 17, wherein searching for specified qualifications includes searching for potential candidates having experience using particular medical equipment.

21. The method according to claim 17, wherein searching for a medical professional includes establishing a longitude and latitude associated with the geographic location of the temporary medical position and longitude and latitude of a potential candidate.

22. The method according to claim 21, wherein establishing a longitude and latitude is based on zip code.

23. The method according to claim 21, wherein searching for a medical professional includes using the longitude and latitude of the geographic location of the temporary medical position and longitude and latitude of the established potential candidate to determine distance between the two.

24. The method according to claim 17, further comprising a setting the predetermined distance by which to restrict searching for a potential candidate.

25. The method according to claim 24, further comprising adjusting the predetermined distance if the searching is unsuccessful.

26. The method according to claim 24, wherein setting the predetermined distance is based on population density at the geographic location.

27. The method according to claim 17, wherein initiating the communication includes sending at least one of the following:
telephone call, email, text message, instant message, and posted message.

28. The method according to claim 27, wherein initiating the communication is performed without human intervention.

29. The method according to claim 17, further comprising in response to the communication, receiving an acceptance or counteroffer of the offered pay rate from the candidate.

30. The method according to claim 29, further comprising continuing to provide communications until negotiations between the medical service provider and potential candiate are complete by the potential candidate accepting or rejecting temporary medical position or the position being filled or withdrawn.

31. The method according to claim 17, further comprising setting the offered pay rate based on historical rates relative to the geographic location.

32. The method according to claim 17, further comprising ranking the one or more potential candidates as a match for the temporary medical position based on the specified qualifications for the temporary medical position and the qualifications of the one or more potential candidates stored in the database.
